(19) United States
(12) Patent Application Publication
(10) Pub. No.: US 2018/0241014 A1
(43) Pub. Date: Aug. 23, 2018

(54) CYLINDRICAL BATTERY

(71) Applicant: TOYOTA JIDOSHA KABUSHIKI KAISHA, Toyota-shi (JP)

(72) Inventors: Masaya MURASE, Nagoya-shi (JP); Yukinari TANABE, Nagoya-shi (JP); Keiji KAITA, Miyoshi-shi (JP); Teruo ISHISHITA, Miyoshi-shi (JP)

(73) Assignee: TOYOTA JIDOSHA KABUSHIKI KAISHA, Toyota-shi (JP)

(21) Appl. No.: 15/890,733

(22) Filed: Feb. 7, 2018

(30) Foreign Application Priority Data
Feb. 21, 2017 (JP) 2017-029873

(51) Int. Cl. H01M 2/04; H01M 2/30; H01M 10/0525; H01M 2/06; H01M 2/08

(52) U.S. Cl. CPC H01M 2/046; H01M 2/0482; H01M 2/08; H01M 10/0525; H01M 2/06; H01M 2/30

(57) ABSTRACT

A cylindrical battery includes a battery case, a cap, an electric insulating ring, and an outer package label. The battery case houses an electrode body therein, and is connected to negative electrodes. The cap includes a first projecting portion sealing a housing opening of the battery case and serving as a positive electrode projection, and a flat portion connected to the first projecting portion, a peripheral edge portion of the flat portion being located adjacent to the battery case with an electric insulator interposed therebetween. The electric insulating ring covers the flat portion and an adjacent portion between the flat portion and the battery case, and is formed with an exposure hole corresponding to the first projecting portion. A second projecting portion is provided on a surface of the flat portion that faces the electric insulating ring.

### INCORPORATION BY REFERENCE

The disclosure of Japanese Patent Application No. 2017-029873 filed on Feb. 21, 2017 including the specification, drawings and abstract is incorporated herein by reference in its entirety.

### BACKGROUND

### 1. Technical Field

The present disclosure relates to a cylindrical battery.

2. Description of Related Art

In a cylindrical battery, an electrode body 102 is housed in a bottomed cylindrical battery case 100, as shown in FIG. 12, for example. After the electrode body 102 is housed, an opening of a top surface of the battery case 100 is sealed by a cap 104. For example, a top part of the battery case 100 is swaged so as to fix the cap 104 to the battery case 100. A negative electrode is connected to the battery case 100, and a positive electrode is connected to the cap 104. In order to prevent short-circuit between the both, the cap 104 is swaged to the battery case 100 via a gasket 106 as an electric insulator.

Even in the above structure, in a swaged portion 117 (see FIG. 13), if an electrically conductive foreign matter comes into contact with the battery case 100 and the cap 104 beyond the gasket 106, short-circuit might be caused. To prevent invasion of such a foreign matter, an electric insulating ring 108 is used in some cases.

The electric insulating ring 108 is an annular disk member, and is disposed on a projecting end 110 of the top surface of the battery case 100. An inner diameter (hole diameter) of the electric insulating ring 108 is formed to be substantially equal to a diameter of a projecting portion 112 of the cap 104. An outer diameter of the electric insulating ring 108 is formed to be substantially equal to a diameter of the battery case 100. The electric insulating ring 108 is fixed by an outer package label 116 with which the battery case 100 is wrapped. The outer package label 116 is composed by heat-shrinkable material such as a Halon tube, for example. A pocket 114 including the swaged portion 117 where the battery case 100 and the cap 104 are located near each other is covered with the electric insulating ring 108 so as to suppress invasion of the foreign matter into the pocket 114.

As a structure on the positive electrode side of such a cylindrical battery, for example, in Japanese Patent Application Publication No. 2008-112603, for the purpose of suppressing an inner diameter side of an electric insulating ring from coming up when the electric insulating ring is tensed at the time of heat-shrinkage of an outer label, a projection is provided to a side surface of a projecting portion of the cap. In Japanese Patent Application Publication No. 2007-242520, for the purpose of suppressing rotation of a cap relative to a battery case, a projection put into a gasket is provided to a contact part of the cap relative to the gasket.

In addition, Japanese Patent Application Publication No. H10-255732, a projection projecting toward an electrode body side (downward) is provided to a flange portion of a cap so as to secure a gap between the cap and a metallic plate in contact with a lower surface of the flange portion. In Japanese Patent Application Publication No. 2012-209177, projections are provided to a contact surface of a cap relative to a PTC element so as to secure electric connection to the PTC element.

### SUMMARY

By the way, the pocket 114 is not completely sealed by the electric insulating ring 108, and a slight gap is formed therebetween. For example, allowances for allowing mass production are specified, so that the gap 118 might be generated between the electric insulating ring 108 and the projecting portion 112. Even though allowances of the diameter of the projecting portion 112 of the cap 104 and of the inner diameter of the electric insulating ring 108 are specified to be smaller so as to eliminate the gap 118, the gap 118 might be generated during the manufacturing process. For example, as shown in FIG. 14, at the time of heat-shrinkage of the outer package label 116, the electric insulating ring 108 is tensed. Then, the inner diameter side thereof comes up. It might result in generation of the gap 118. In such a case, as shown in FIG. 15, it might happen that an electrically conductive foreign matter 119 invades into the gap 118, moves in the pocket 114 to reach the swaged portion 117, and causes short-circuit between the battery case 100 (the negative electrode) and the cap 104 (the positive electrode).

The present disclosure provides a cylindrical battery capable of suppressing short-circuit caused by a foreign matter more than the related art does.

An aspect of the disclosure provides a cylindrical battery. The cylindrical battery includes: a battery case housing an electrode body and being connected to a negative electrode; a cap including a first projecting portion sealing an opening of the battery case and serving as a positive electrode projection, and a flat portion connected to the first projecting portion, a peripheral edge portion of the flat portion being adjacent to the battery case with an electric insulator interposed between the peripheral edge portion and the battery case; an electric insulating ring covering the flat portion and an adjacent portion between the flat portion and the battery case, the electric insulating ring provided with an exposure hole corresponding to the first projecting portion; and an outer package label covering outer surfaces of the electric insulating ring and the battery case and fixing the electric insulating ring to the battery case. The cap includes a second projecting portion on a surface of the flat portion that faces the electric insulating ring, the second projecting portion projecting toward the electric insulating ring.

By providing the flat portion of the cap with the second projecting portion, even if a foreign matter invades from a gap between the first projecting portion of the cap and the electric insulating ring, it is possible to block movement of the foreign matter by this second projecting portion. As a result, it is possible to suppress short-circuit between the flat portion and the battery case caused by the foreign matter.

In the above aspect, the second projecting portion may be provided such that there is a gap between the second projecting portion and the electric insulating ring.

By providing the gap while the top surface of the second projecting portion is out of contact with the bottom surface of the electric insulating ring, it is possible to secure a volatilization passage of an electrolytic solution having oozed from the adjacent portion (the swaged portion) between the flat portion and the battery case.

In the above aspect, a diameter of the exposed hole of the electric insulating ring may be larger than a diameter of the first projecting portion, and the second projecting portion may be located more circumferentially outward than a gap between the electric insulating ring and the first projecting portion.

By providing the second projecting portion more circumferentially outward than the gap between the electric insulating ring and the first projecting portion, it is possible to securely block movement of the foreign matter toward the swaged portion.

In the above aspect, a side wall of the first projecting portion may have a rickrack form, and the electric insulating ring may be disposed such that the electric insulating ring is put into a trough of the side wall in the rickrack form.

The electric insulating ring is put into a trough of the side wall in a rickrack form, so that the gap between the first projecting portion and the electric insulating ring becomes a zig zag form, to thus suppress invasion of the foreign matter.

In the above aspect, the first projecting portion may include an upper surface having a circular shape and a side surface connected to a peripheral edge portion of the upper surface. And in a cross section passing through a center of the upper surface and vertical to the upper surface, a straight line, passing through the peripheral edge portion of the upper surface of the first projecting portion and an end portion of the electric insulating ring located on a flat portion side in a peripheral edge portion of the exposure hole, may intersect the second projecting portion.

In the above aspect, the second projecting portion may be a different member from the cap fixed on the flat portion.

In the above aspect, the second projecting portion may be composed of a part of the flat portion that is bent toward the electric insulating ring.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1. is a sectional view showing an example of a cylindrical battery according to a first embodiment;

FIG. 2. is an enlarged sectional view of a vicinity of a swaged portion of the cylindrical battery according to the first embodiment;

FIG. 3. is an enlarged sectional view of the vicinity of the swaged portion of the cylindrical battery according to the first embodiment, showing another example of a second projection portion;

FIG. 4. is a view explaining a blocking effect of blocking a foreign matter by the second projecting portion;

FIG. 5. is a view explaining a dimension and a shape of the second projecting portion, and others;

FIG. 6. is an enlarged sectional view of the vicinity of the swaged portion of the cylindrical battery according to the first embodiment, showing further another example of the second projection portion;

FIG. 7. is a sectional view showing an example of a cylindrical battery according to a second embodiment;

FIG. 8. is an enlarged sectional view of the vicinity of the swaged portion of the cylindrical battery according to the second embodiment;

FIG. 9. is a view explaining a blocking effect of blocking a foreign matter by a side wall in a rickrack form;

FIG. 10. is a view explaining a dimension and a shape of the side wall in a rickrack form, and others;

FIG. 11. is an enlarged sectional view of the vicinity of the swaged portion of a cylindrical battery according to a third embodiment;

FIG. 12. is a sectional view showing an example of a cylindrical battery of the related art;

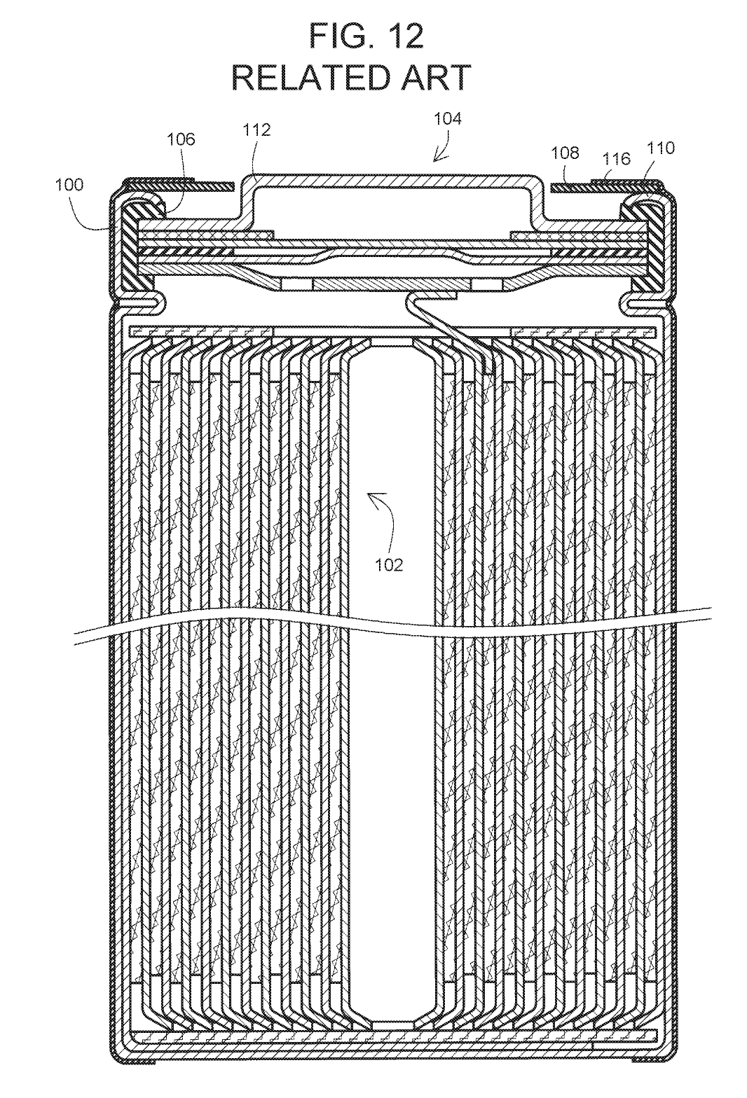

FIG. 13. is an enlarged sectional view of a vicinity of a swaged portion of the cylindrical battery according to the related art;

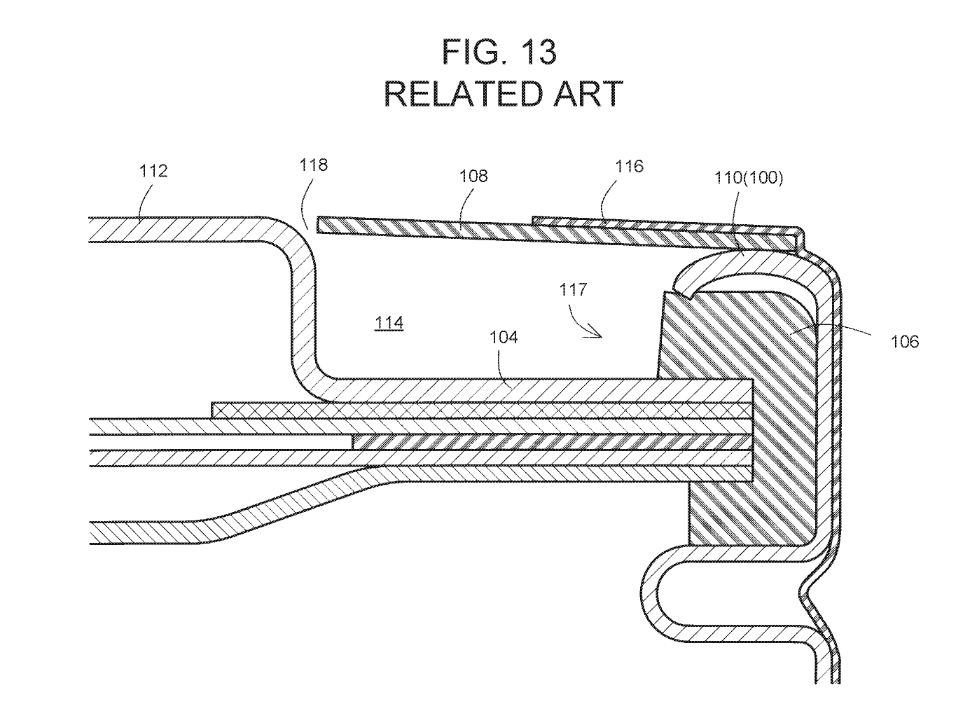

FIG. 14. is an enlarged sectional view of another example of the vicinity of the swaged portion of the cylindrical battery according to the related art; and

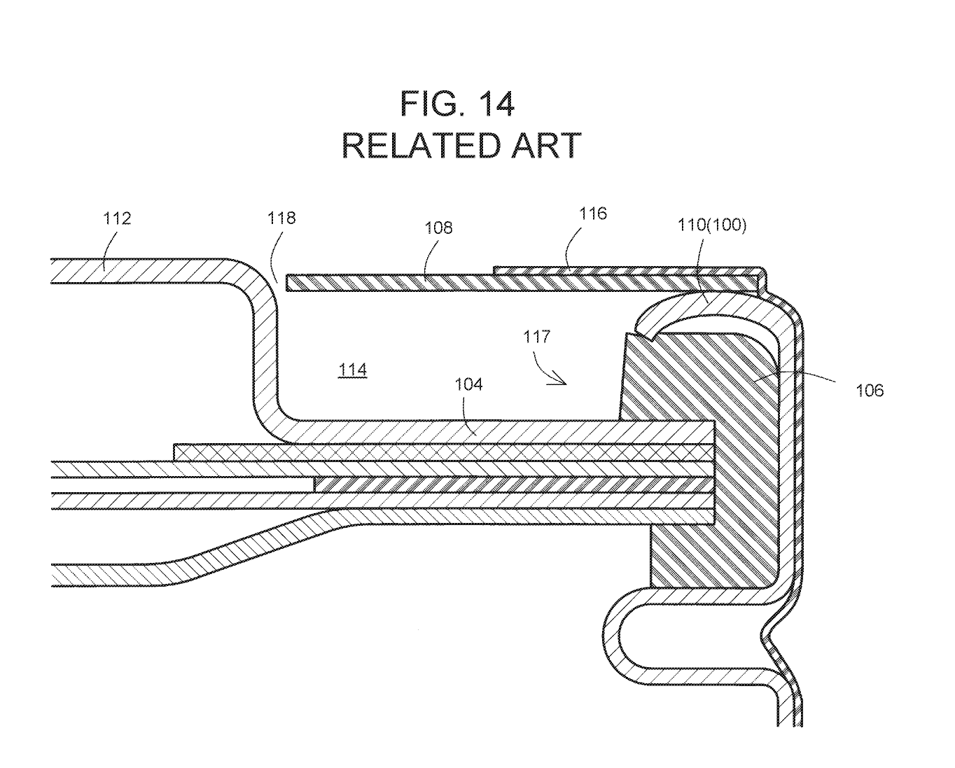

FIG. 15. is a view explaining short-circuit caused to the swaged portion of the cylindrical battery of the related art.

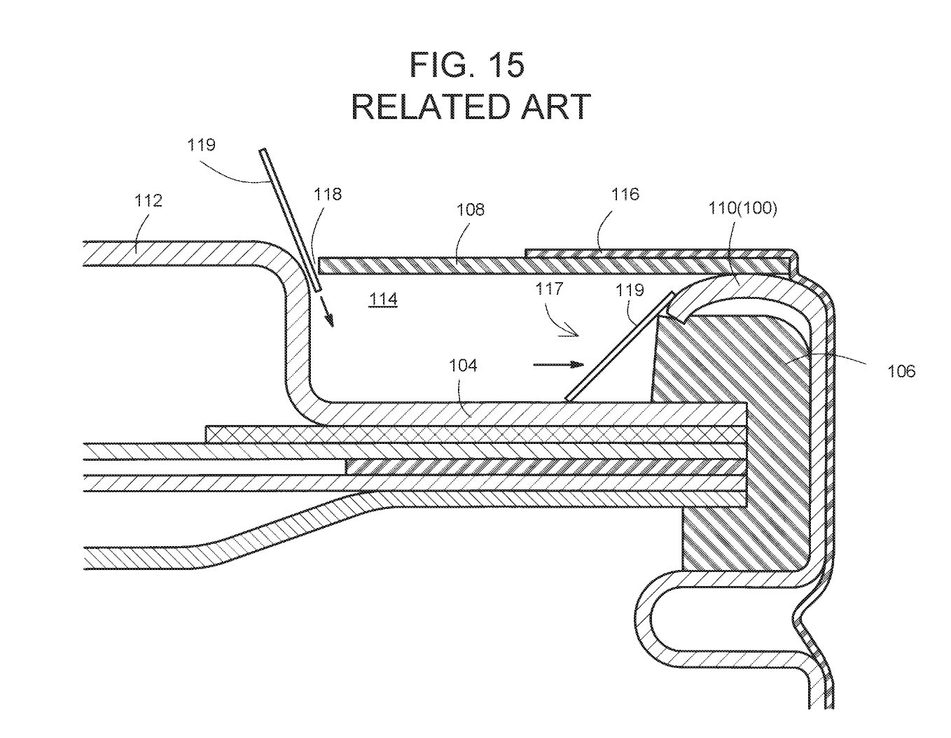

### DETAILED DESCRIPTION OF EMBODIMENTS

### First Embodiment

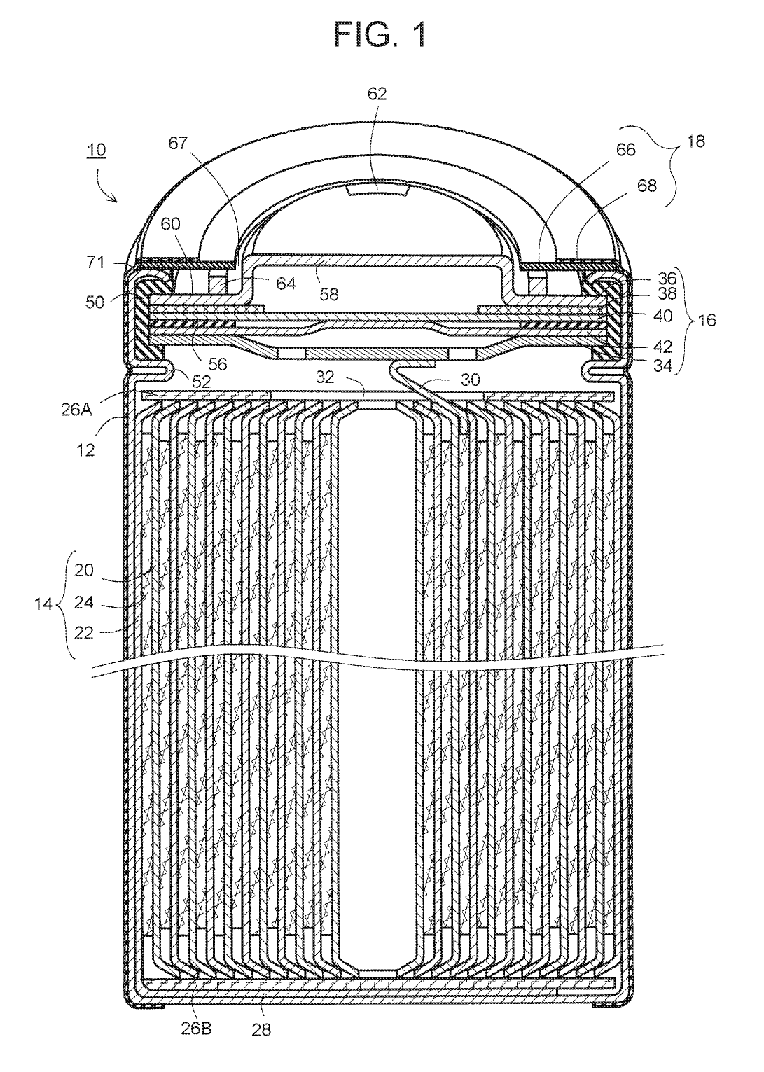

FIG. 1 shows an example of a sectional view of a cylindrical battery 10 according to the present embodiment (first embodiment). The cylindrical battery 10 may be a cylindrical battery of 18650-type as a lithium-ion rechargeable battery, for example. In the following description, a configuration of the cylindrical battery 10 while a positive electrode side is located at an upper position (top surface side), and a negative electrode side is located at a lower position (bottom surface side) will be described, appropriately.

The cylindrical battery 10 includes a battery case 12, an electrode body 14, a seal unit 16, and an outer package unit 18.

The battery case 12 is a bottomed cylindrical housing member, and is composed of electrically conductive material such as aluminum. As described later, the battery case 12 is connected to negative electrodes 22.

The electrode body 14 includes positive electrodes 20, negative electrodes 22, and separators 24. For example, as shown in FIG. 1, a layered body formed by layering the positive electrodes 20 and the negative electrodes 22 with the separators 24 interposed therebetween in a state of being wound is housed in the battery case 12. The wound electrode body 14 is held at the top and the bottom (the positive electrode side and the negative electrode side) thereof by electric insulators 26A, 26B. The battery case 12 is charged with an electrolytic solution such as nonaqueous electrolyte, and the electrode body 14 is soaked in this electrolytic solution.

In addition, a negative-electrode lead 28 is extendingly provided from the negative electrodes 22 of the electrode body 14. The negative-electrode lead 28 is provided around under the electric insulator 26B to be connected (electrically connected) to the battery case 12. A positive-electrode lead 30 is extendingly provided from the positive electrodes 20 of the electrode body 14. The positive-electrode lead 30 is connected (electrically connected) to a filter 34 of the seal unit 16 via an opening 32 of the electric insulator 26A.

The seal unit 16 seals a housing opening of the battery case 12. The seal unit 16 includes a cap 36, a PTC element 38, an upper valve element 40, a lower valve element 42, and a filter 34. These components are all formed into generally disk shapes so that they can be housed in the battery case 12. Each member of the seal unit 16 is composed by electrically conductive material.

The seal unit 16 is fixed to the battery case 12 via a gasket 50 as an electric insulator. For example, as shown in FIG. 1, by swaging (plastically deforming) the battery case 12, the seal unit 16 is held and fixed between a recessed portion 52 and an upper edge portion 71 (turned-up portion) of the battery case 12 via the gasket 50.

The respective components of the seal unit 16 are well known, and thus these components will be simply described, herein. The cap 36 will be described later in detail. The positive-electrode lead 30 extending from the positive electrodes 20 is connected to the filter 34, and the filter 34, the lower valve element 42, the upper valve element 40, the PTC element 38, and the cap 36 are electrically connected to one another.

The upper valve element 40 and the lower valve element 42 have function as current interrupt devices (CIDs). Each of the upper valve element 40 and the lower valve element 42 has a contact at its center, and a peripheral edge thereof around the center is insulated by a gasket 56. The portion thereof around the contact is formed to be a thin wall portion so that the contact is brought to be broken from the thin wall portion so as to release gas in the battery case 12 to the outside when an inner pressure of the battery case 12 becomes increased. Due to breakage of the contact, the upper valve element 40 and the lower valve element 42 come out of contact from each other, to thus shut off current supply.

The PTC element 38 is a passive element to prevent large current, and is formed by material increasing resistance in proportion to increase in current. When large current flows, the PTC element 38 reduces the current.

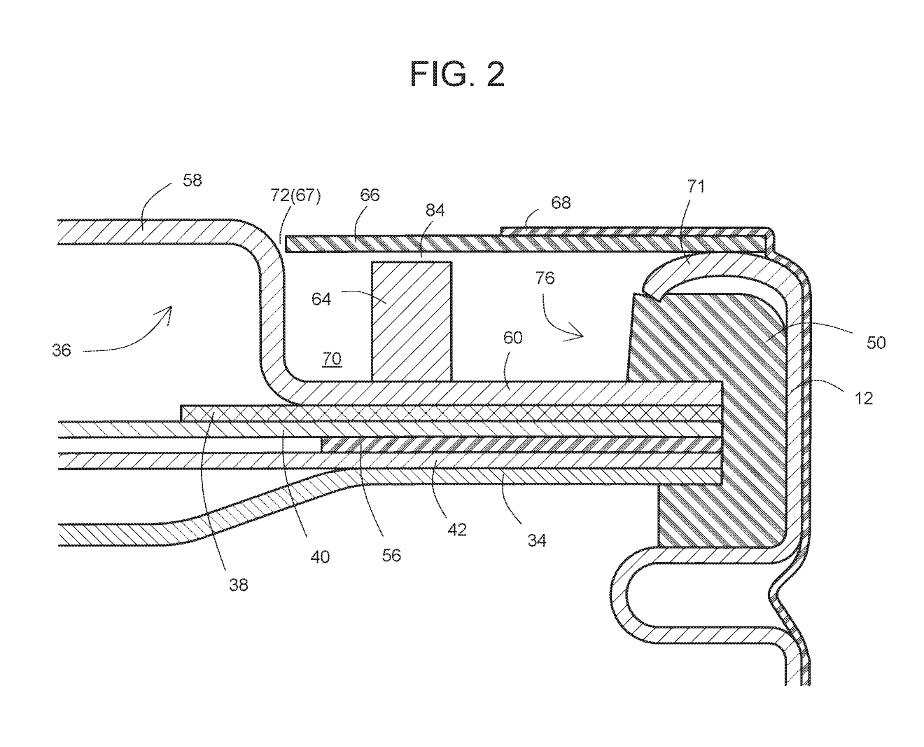

The outer package unit 18 includes an electric insulating ring 66 and an outer package label 68. The electric insulating ring 66 is an electric insulating member covering a flat portion 60 of the cap 36. More specifically, as shown in FIG. 2, the electric insulating ring 66 covers the flat portion 60 together with a swaged portion 76 that is a near (adjacent) portion between the battery case 12 and the flat portion 60. Through this, a pocket 70 formed between a first projecting portion 58 and the upper edge portion 71 of the battery case 12 is covered with the electric insulating ring 66.

The electric insulating ring 66 is composed by an annular disk member, and is formed at its center with an exposure hole 67 corresponding to the first projecting portion 58 of the cap 36. A diameter of the exposure hole 67 is formed so as to be slightly larger than a diameter of the first projecting portion 58. Hence, a gap 72 is formed between the electric insulating ring 66 and the first projecting portion 58 of the cap 36. As described later, the gap 72 serves as a gas discharge passage for gas volatilized from the electrolytic solution having oozed from the swaged portion 76.

The outer package label 68 is an outer package of the cylindrical battery 10, and covers respective outer surfaces of the electric insulating ring 66 and the battery case 12 so as to fix the both. The outer package label 68 is composed by heat-shrinkable material such as a halon tube, for example. The electric insulating ring 66 is placed on the upper edge portion 71 of the battery case 12, and this assembled body is covered with the outer package label 68, and is then heated so that the outer package label 68 is shrunken to hold and fix the electric insulating ring 66 to the battery case 12. The outer package label 68 has a shape defined in such a manner as to expose a part of the electric insulating ring 66 and a part of the negative-electrode end (bottom surface) of the battery case 12.

The cap 36 is a positive electrode terminal of the cylindrical battery 10, and is a member having a hat-like cross sectional shape and including the first projecting portion 58 and the flat portion 60. The first projecting portion 58 is a positive projection of the cylindrical battery 10, and is formed to have a U-shaped sectional shape. The first projecting portion 58 is formed with at least one gas discharge hole 62 (see FIG. 1). It is suitable to arrange the gas discharge hole 62 so as not to hinder connection to an external terminal, and is disposed around a peripheral edge portion of the first projecting portion 58, for example. The gas discharge hole 62 communicates with respective contacts of the upper valve element 40 and the lower valve element 42, and when the contacts become broken, the gas in the inside is discharged to the outside of the battery through the gas discharge hole 62.

The flat portion 60 corresponds to a brim portion of the cap 36 in a hat shape. That is, the flat portion 60 is connected to a side surface of the first projecting portion 58. The peripheral edge portion of the flat portion 60 is located close to the battery case 12 with the gasket 50 as an electric insulator interposed therebetween.

With reference to FIG. 2, as aforementioned, the flat portion 60 and the swaged portion 76 that is an adjacent portion between the battery case 12 and the flat portion 60 is covered with the electric insulating ring 66, but the gap 72 is formed between the first projecting portion 58 and the electric insulating ring 66, so that a foreign matter might invade into the pocket 70. To cope with this, in the present embodiment, the flat portion 60 is provided with a second projecting portion 64 to block a foreign matter from further progressing (moving) to the swaged portion 76 when the foreign matter invades from the gap 72 into the pocket 70.

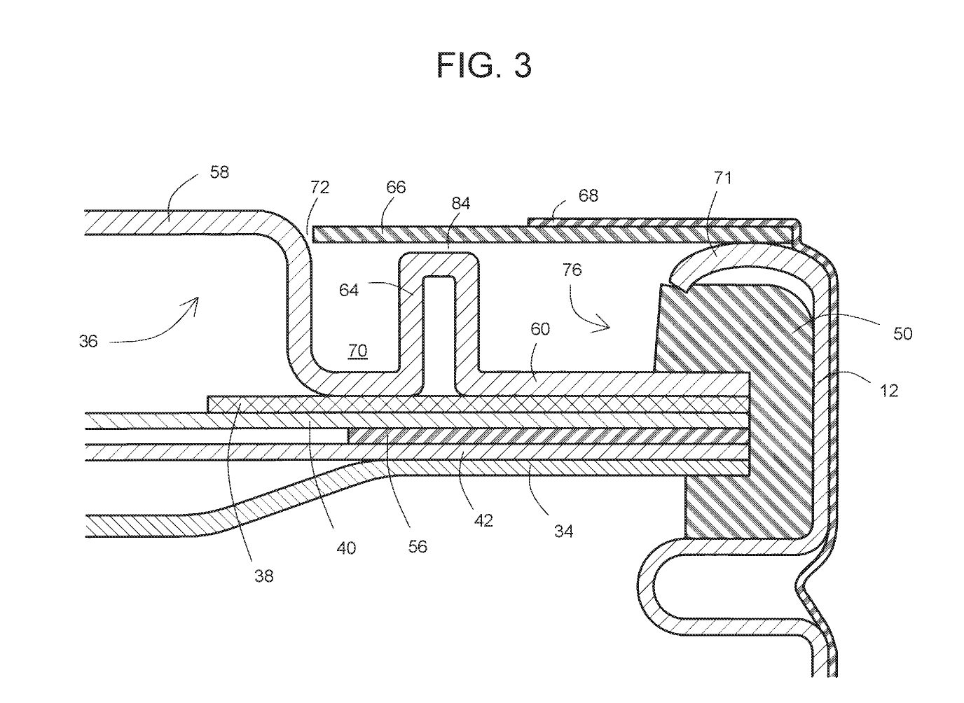

The second projecting portion 64 is provided to a surface of the flat portion 60 that faces the electric insulating ring 66. The second projecting portion 64 may be a different member from the cap 36, as shown in FIG. 2, or may be formed by press-forming the flat portion 60 of the cap 36, or the like, as shown in FIG. 3.

The second projecting portion 64 is extendingly provided so as to surround the first projecting portion 58 on the flat portion 60 in plan view (if the cylindrical battery 10 is viewed from the positive electrode side). The second projecting portion 64 may have a shape concentric to the first projecting portion 58, for example, or may have an oval shape having a non-constant clearance from the first projecting portion 58. The second projecting portion 64 may be extendingly provided in a polygonal shape.

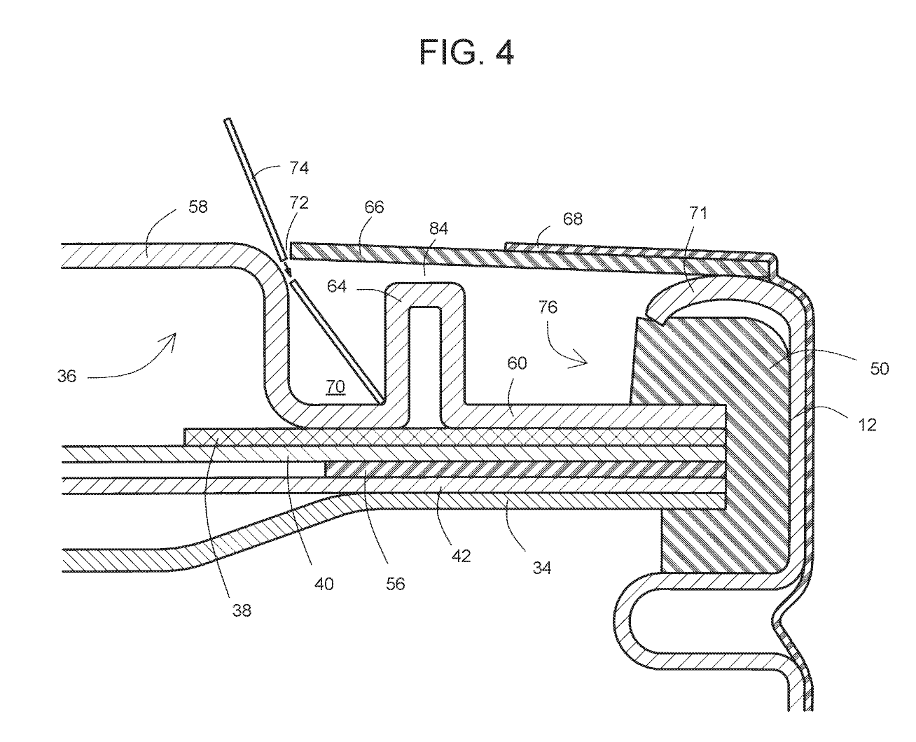

As shown in FIG. 4, when a foreign matter 74 invades into the pocket 70 from the gap 72 between the first projecting portion 58 and the electric insulating ring 66, the foreign matter 74 is caught by the second projecting portion 64 so as to be blocked from reaching the swaged portion 76 where the battery case 12 and the flat portion 60 get close to each other.

In addition, a gap 84 may be formed between the second projecting portion 64 and the electric insulating ring 66. Due to increase in internal pressure of the battery, the electrolytic solution with which an electrode body 14 is impregnated might ooze from between the gasket 50 and the battery case 12, or from between the gasket 50 and the seal unit 16. In such a case, the electrolytic solution having oozed is volatilized from the gap 84 between the second projecting portion 64 and the electric insulating ring 66, and further is discharged from the gap 72 between the electric insulating ring 66 and the first projecting portion 58 of the cap 36 to the outside of the battery.

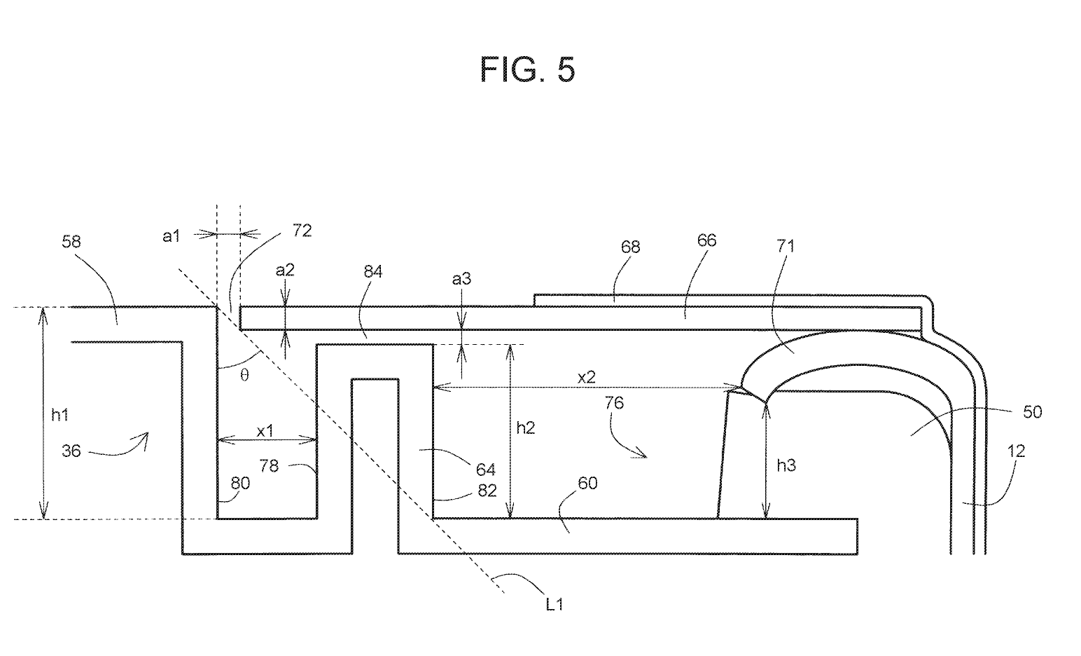

With reference to FIG. 5, the shape and the dimension of the second projecting portion 64 will be described. In FIG. 5, an R shape of a formation part of the cap 36 (turned-up portion) is ignored, and is illustrated by using straight lines and a right angle.

If a width of the gap 72 is defined as a1, and a thickness of the electric insulating ring 66 is defined as a2, an angle θ can be found by tan θ=a1/a2. A broken line L1 of this angle θ is an invasion path where the foreign matter 74 comes closest to the swaged portion 76. The position of the second projecting portion 64 is defined such that its side surface 78 on the first-projecting-portion side intersects the broken line L1. For example, the second projecting portion 64 may be formed more circumferentially outward than the gap 72. Through this, it is possible to securely block the foreign matter 74 by the second projecting portion 64.

For example, a clearance x1 of the side surface 78 on the first-projecting-portion side of the second projecting portion 64 from a side surface 80 of the first projecting portion 58 may be x1>(h1−h2)tan θ, using a height h1 from the upper surface of the first projecting portion 58 to the upper surface of the flat portion 60, a height h2 of the second projecting portion 64, and the angle θ.

A clearance X2 between an outer circumferential side surface 82 of the second projecting portion 64 and the upper edge portion 71 of the battery case 12 may be equal to or larger than a minimum distance between the positive electrode 20 and the negative electrode 22, that is, for example, equal to or larger than a clearance h3 between the upper edge portion 71 and the flat portion 60.

In addition, as a volatilization passage of the electrolytic solution having oozed from the swaged portion 76, the gap 84 between the second projecting portion 64 and the electric insulating ring 66 is provided. Here, in light of blocking invasion of the foreign matter 74, the second projecting portion 64 is preferably close to the electric insulating ring 66, that is, it is preferable to narrow the gap 84. Here, a width a3 of the gap 84 may be found based on an allowance of the electric insulating ring 66 and an allowance of the cap 36, for example. For example, a width a3 of the gap 84 may be not less than 0.1 mm.

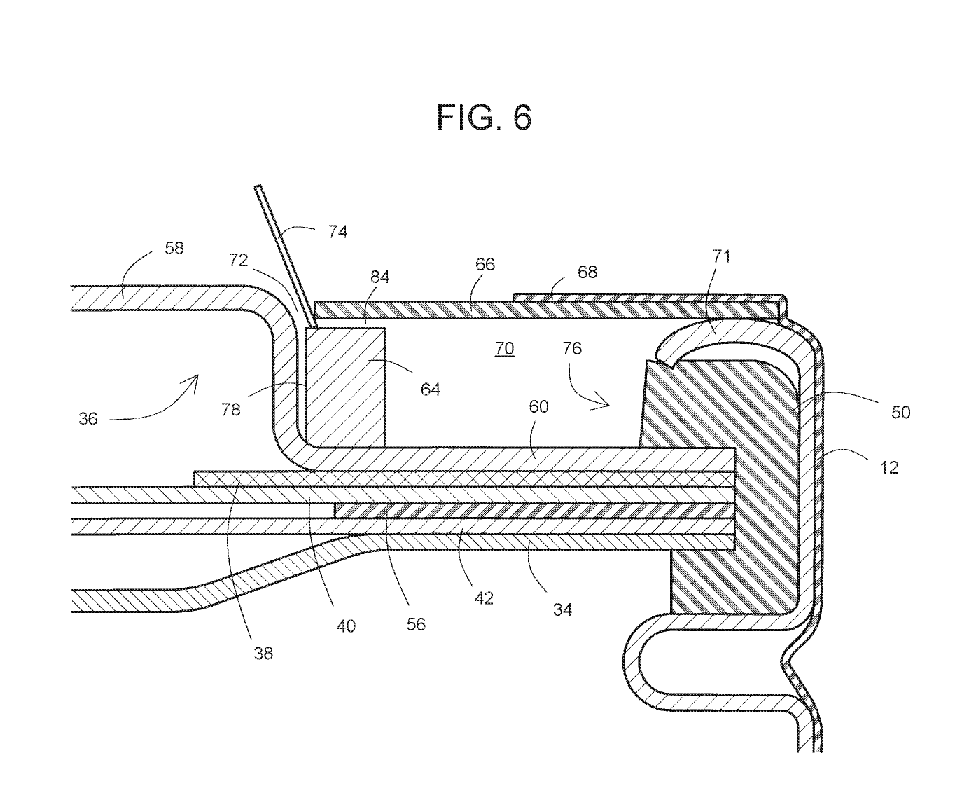

In an example of FIG. 5, the second projecting portion 64 is disposed more circumferentially outward than the gap 72, but the present disclosure is not limited to this manner. For example, as shown in FIG. 6, the second projecting portion 64 may be formed such that the side surface 78 on the first-projecting-portion side may be disposed more circumferential inward than the gap 72. Through this, when the foreign matter 74 comes into contact with the top surface of the second projecting portion 64, the foreign matter 74 is blocked from further invading into the pocket 70.

### Second Embodiment

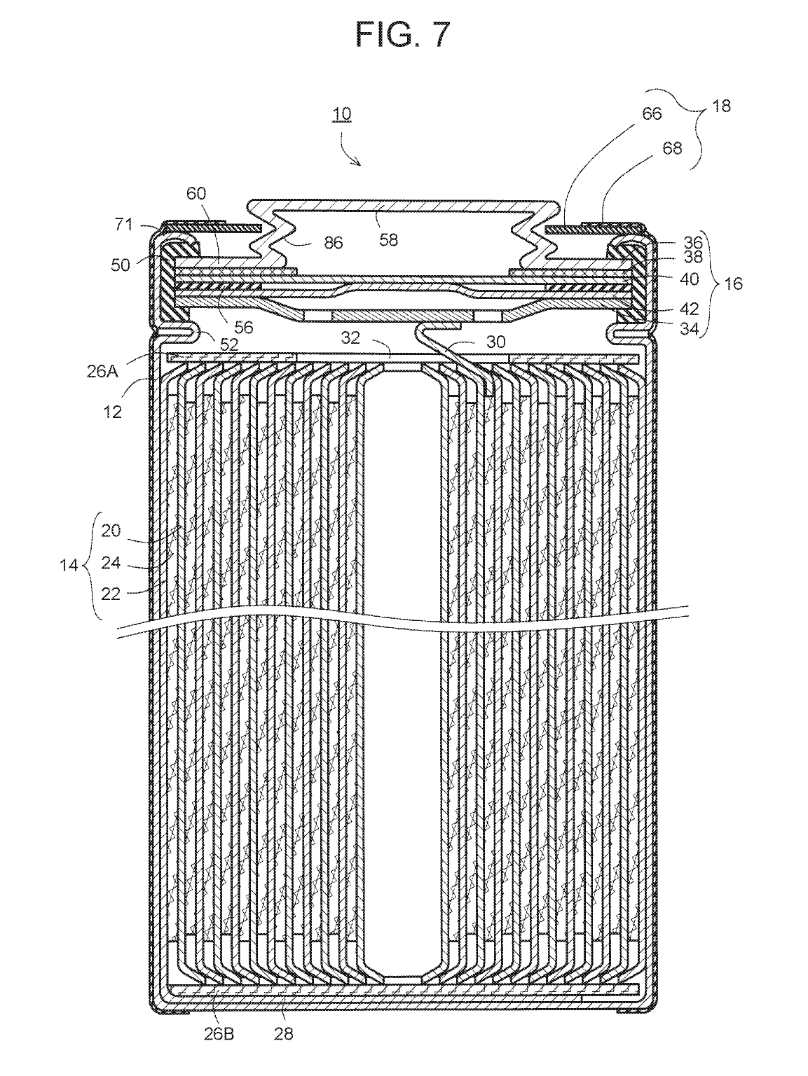

FIG. 7 shows an example of the cylindrical battery 10 according to the second embodiment. The cylindrical battery 10 is different from the cylindrical battery 10 in FIG. 1 in the shape of the cap 36 and the arrangement of the electric insulating ring 66. The other configurations thereof are the same as those in FIG. 1, and thus description thereof will be appropriately omitted.

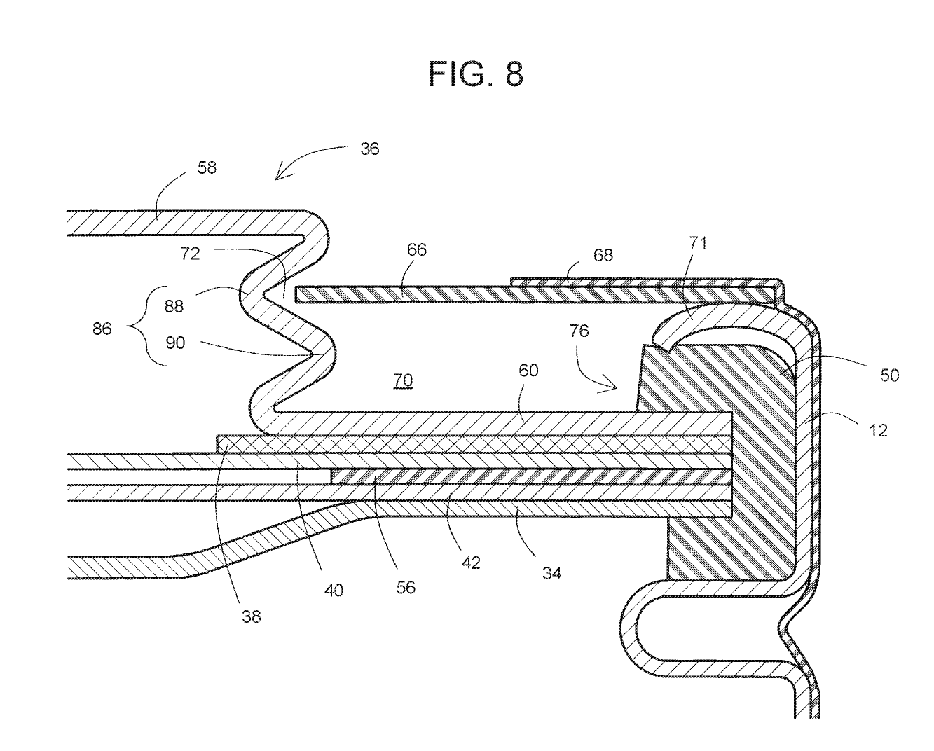

FIG. 8 shows an enlarged sectional view of the vicinity of the swaged portion 76 of the cylindrical battery according to the second embodiment. In this embodiment, a side wall 86 of the first projecting portion 58 of the cap 36 is formed into a rickrack form (zigzag form). That is, the side wall 86 of the first projecting portion 58 has a trough 88 bent in an inward direction of the first projecting portion 58 between the upper surface of the first projecting portion 58 and the upper surface of the flat portion 60. In addition, the electric insulating ring 66 is disposed in the trough 88 of the side wall 86 in a rickrack form, that is, in a manner as to be put into a relative small diameter portion. The side wall 86 and the electric insulating ring 66 are slightly apart from each other so as to form the gap 72 for discharging the gas. In FIG. 7 and FIG. 8, at a lower part of a crest 90 in the side wall 86, a diameter of the first projecting portion becomes smaller as this goes downward in the height direction, but the first projecting portion may have a constant diameter at the lower part from the top of the crest 90, for example.

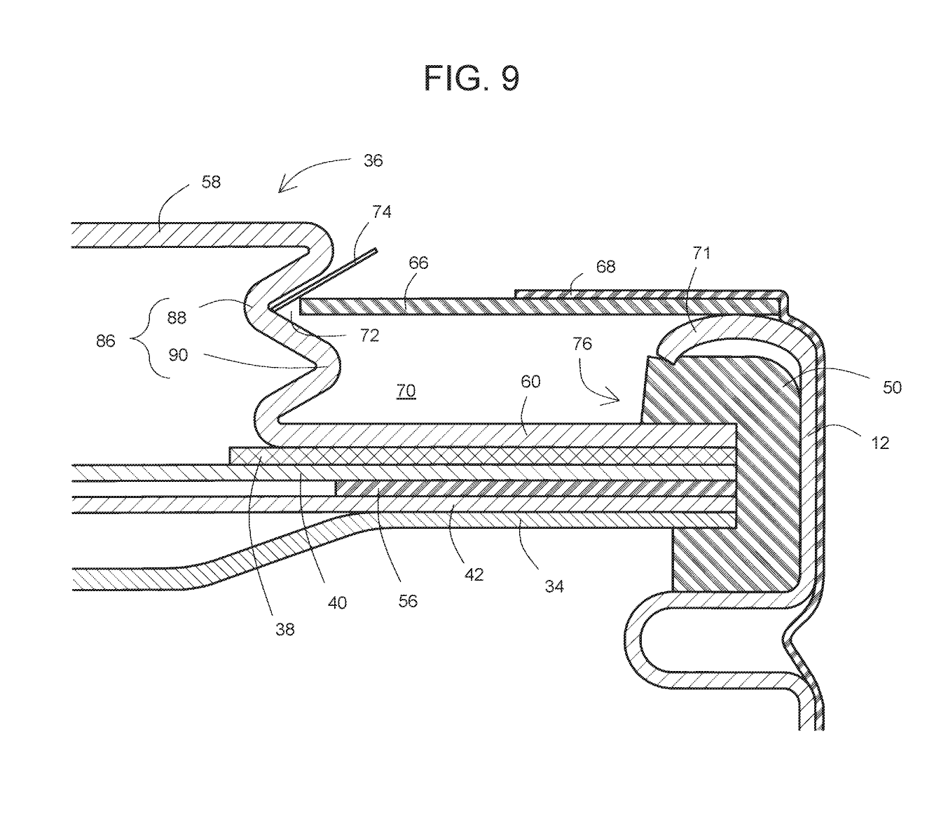

With the above configuration, as shown in FIG. 9, even if the foreign matter 74 invades into the gap 72 between the cap 36 and the electric insulating ring 66, the foreign matter 74 is blocked from further invading by the crest 90 located at a lower position (on the negative electrode side). As a result, short-circuit between the battery case 12 and the flat portion 60 in the swaged portion 76 can be prevented.

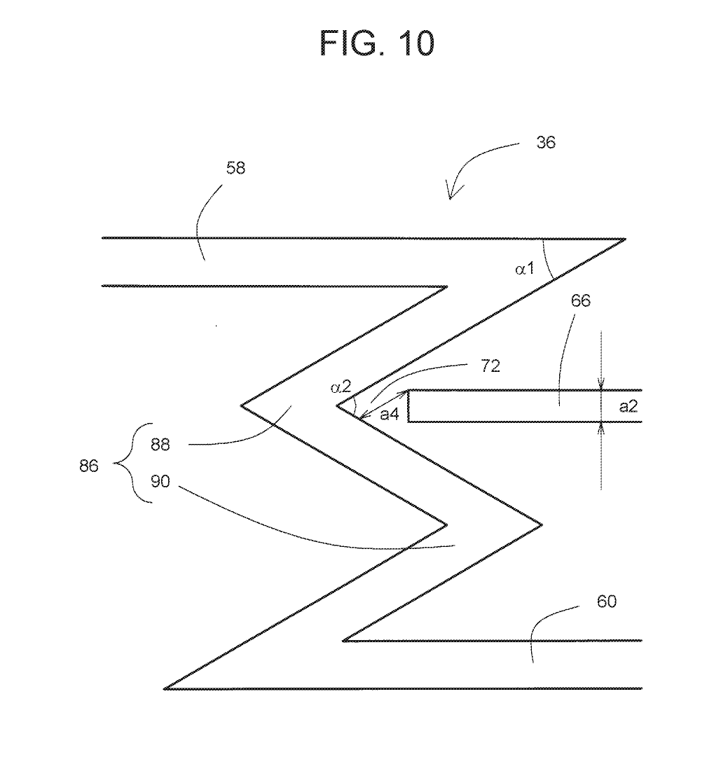

With reference to FIG. 10, the shape and the dimension of the side wall 86 of the cap 36 will be described. In FIG. 10, the R shape of the formation part of the cap 36 (turned-up portion) is ignored, and is illustrated by using straight lines and a right angle.

A distance a4 between the electric insulating ring 66 and the side wall 86 may be equal to or less than the minimum distance between the positive electrode 20 and the negative electrode 22, that is, equal to or less than the clearance h3 between the upper edge portion 71 and the flat portion 60, for example (see FIG. 5). Angles a1, a2 of the side wall 86 are preferably set to be angles that can prevent invasion of the foreign matter 74 as well as allow the insertion of the electric insulating ring 66. For example, a1 is defined to be 45° or less, and a2 is defined to be 90° or less.

### Third Embodiment

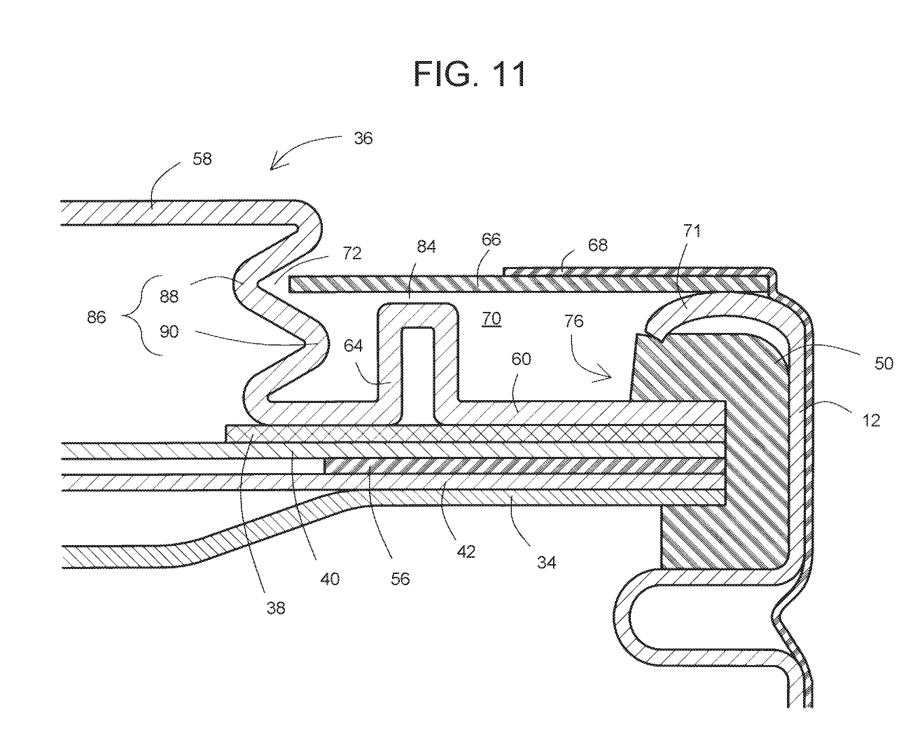

FIG. 11 shows an example of the cylindrical battery 10 according to the third embodiment. The cylindrical battery 10 is different from the cylindrical battery 10 in FIG. 1 in the shape of the cap 36 and the arrangement of the electric insulating ring 66. The other configurations thereof are the same as those in FIG. 1, and thus description thereof will be appropriately omitted.

FIG. 11 shows an enlarged sectional view in the vicinity of the swaged portion 76. This embodiment is configured in combination of the first embodiment and the second embodiment, and the side wall 86 of the cap 36 is formed in a rickrack form, and the flat portion 60 is formed with the second projecting portion 64. The side wall 86 conforms to the configuration of the second embodiment, and the second projecting portion 64 conforms to the configuration of the first embodiment.

By employing the structure in which the electric insulating ring 66 is put into the side wall 86 in a rickrack form, the foreign matter 74 is blocked from further moving from the gap 72 deep into the pocket 70 (swaged portion 76). Further, even if the foreign matter 74 invades into the pocket 70, progress of the foreign matter 74 is then prevented by the second projecting portion 64. As a result, short-circuit in the swaged portion 76 caused by the foreign matter 74 is prevented.

What is claimed is:

1. A cylindrical battery comprising:
a battery case housing an electrode body and being connected to a negative electrode;
a cap including
a first projecting portion sealing an opening of the battery case and serving as a positive electrode projection, and
a flat portion connected to the first projecting portion, a peripheral edge portion of the flat portion being adjacent to the battery case with an electric insulator interposed between the peripheral edge portion and the battery case;
an electric insulating ring covering the flat portion and an adjacent portion between the flat portion and the battery case, the electric insulating ring provided with an exposure hole corresponding to the first projecting portion; and
an outer package label covering outer surfaces of the electric insulating ring and the battery case and fixing the electric insulating ring to the battery case, wherein
the cap includes a second projecting portion on a surface of the flat portion that faces the electric insulating ring, the second projecting portion projecting toward the electric insulating ring.

2. The cylindrical battery according to claim 1, wherein
the second projecting portion is provided such that there is a gap between the second projecting portion and the electric insulating ring.

3. The cylindrical battery according to claim 1, wherein
a diameter of the exposed hole of the electric insulating ring is larger than a diameter of the first projecting portion, and
the second projecting portion is located more circumferentially outward than a gap between the electric insulating ring and the first projecting portion.

4. The cylindrical battery according to claim 1, wherein
a side wall of the first projecting portion has a rickrack form, and the electric insulating ring is disposed such that the electric insulating ring is put into a trough of the side wall in the rickrack form.

5. The cylindrical battery according to claim 1, wherein
the first projecting portion includes an upper surface having a circular shape and a side surface connected to a peripheral edge portion of the upper surface, and
in a cross section passing through a center of the upper surface and vertical to the upper surface,
a straight line, passing through the peripheral edge portion of the upper surface of the first projecting portion and an end portion of the electric insulating ring located on a flat portion side in a peripheral edge portion of the exposure hole, intersects the second projecting portion.

6. The cylindrical battery according to claim 1, wherein
the second projecting portion is a different member from the cap fixed on the flat portion.

7. The cylindrical battery according to claim 1, wherein
the second projecting portion is composed of a part of the flat portion that is bent toward the electric insulating ring.
